(19) United States
(12) Patent Application Publication
(10) Pub. No.: US 2003/0225842 A1
(43) Pub. Date: Dec. 4, 2003

(54) Distribution of messages using an address book of a user

(76) Inventors: Kenneth Li, Arcadia, CA (US); Daniel Kwoh, La Canada, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/358,015

(22) Filed: Feb. 3, 2003

Related U.S. Application Data
(63) Continuation of application No. 10/159,595, filed on May 29, 2002, now abandoned.
(60) Provisional application No. 60/294,087, filed on May 29, 2001.

(51) Int. Cl. G06F 15/16

(52) U.S. Cl. 709/206

(57) ABSTRACT

A method utilizing a computer for distributing a preselected message using electronic mail addresses stored on a user device. The method includes receiving a request to send the preselected message to e-mail addresses stored on the user device, retrieving e-mail addresses stored on the user device, and sending the preselected message to the e-mail addresses retrieved from the user device.

### CROSS-REFERENCE TO RELATED APPLICATION

This application is a continuation of U.S. patent application Ser. No. 10/159,595, filed on May 29, 2002, which claims priority of U.S. Provisional Patent Application No. 60/294,087, filed on May 29, 2001, the entire contents of which are hereby incorporated herein by reference.

### BACKGROUND OF THE INVENTION

As electronic commerce becomes more popular, more websites are emerging and entering into businesses that provide convenience and value to consumers. Advertising a website name and the URL of the website to the general public is often a time consuming and expensive task. Some of the existing channels for publicizing a website and its URL are radio and television advertising, billboards, word of mouth, magazines, and banner advertisements on other websites.

Much of the advertising requires a potential website viewer to memorize or write down the URL of the website for later viewing at a computer. Moreover, the cost of marketing may be so expensive as to be a detriment to the profitability of the business. Therefore, there is a need for a cheaper and more effective method of marketing websites.

### SUMMARY OF THE INVENTION

The present invention, according to an exemplary embodiment, is to a method utilizing a computer for distributing a preselected message using electronic mail (e-mail) addresses stored on a user device. The method includes receiving a request to send the preselected message to e-mail addresses stored on the user device, retrieving e-mail addresses stored on the user device, and sending the preselected message to the e-mail addresses retrieved from the user device.

In an embodiment, the operating system and the user device type are checked and an address retrieval program specific to the operating system and device type of the system is transferred to the user device. In an alternative embodiment, the user device is checked to determine whether an address retrieval program is already stored in the user device. If no address retrieval program is stored in the user device, then an address retrieval program is transferred to the user device.

In an additional embodiment, the user is prompted to select at least one of the retrieved e-mail addresses to receive the preselected message. In another embodiment, the user is prompted to enter a personal message to be sent to the retrieved e-mail addresses along with the preselected message. In yet another embodiment, the number of addresses the message is sent to is tracked. The retrieved e-mail addresses may be sent to a server. Additionally, the preselected messages may be addressed with the retrieved e-mail address listed as a blind carbon copy and the user listed as the sender.

The present invention is also directed to a system for distributing messages to electronic mail addresses. The system, according to an embodiment, has a message server coupled to a computer network and a user terminal coupled to the computer network. The message server is configured to receive a request to send a message to e-mail addresses stored on the user terminal. The message server is also configured to retrieve electronic mail addresses stored on the user device. The message server is also configured to send a message to the e-mail addresses retrieved from the user device.

The present invention is also directed to a computer readable medium storing instructions for distributing messages. The instructions, when executed by a microprocessor cause the microprocessor to perform the step of prompting a user to send a message to the e-mail addresses stored on a user device. The instructions also cause the microprocessor to receive a request to send a message to e-mail addresses stored on the user device. In response to the receipt of a request, the instructions cause the microprocessor to retrieve e-mail addresses stored on the user device. The instructions also cause the microprocessor to send the message to the e-mail addresses retrieved from the user device.

### BRIEF DESCRIPTION OF THE DRAWINGS

These and other features and advantages of the present invention will be better understood by reference to the following detailed description when considered in conjunction with the accompanying drawings wherein:

FIG. 1 is a block diagram showing the relationship of parts of a system for distribution of messages using an address book of a user in accordance with an embodiment of the present invention;

FIG. 2 is a block diagram of a system for distribution of messages using an address book of a user in accordance with an embodiment of the present invention;

FIG. 3 is a flowchart showing the steps for distribution of messages using an address book of a user in accordance with an embodiment of the present invention;

FIG. 4 is an examplary structure of an address book file; and

FIG. 5 is a decision screen sent to a user prompting the user to select recipients of a message and to enter a personal message to send to recipients in accordance with an embodiment of the present invention.

### DETAILED DESCRIPTION OF THE INVENTION

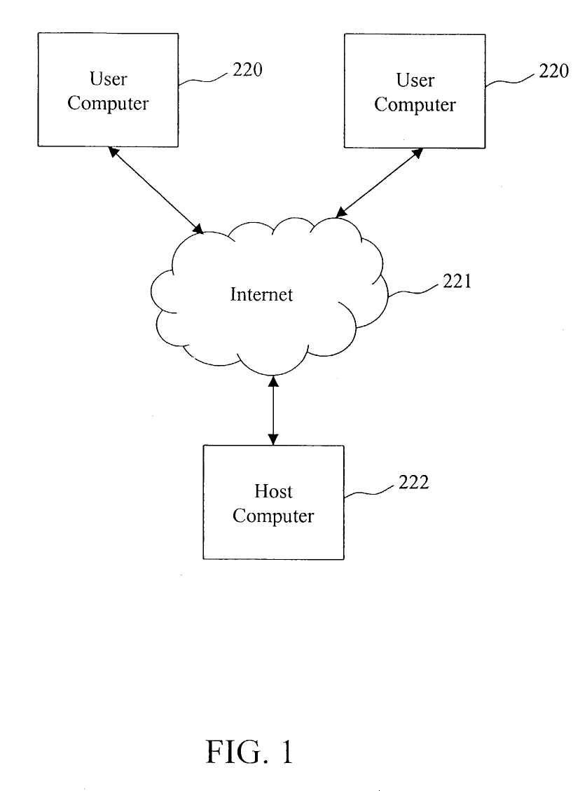

An overview of a message distribution system according an embodiment of the present invention is shown in FIG. 1. The system functions between user devices 220 and a server 222 communicating through the Internet 221. The server 222 communicates a user interface to a user device. Depending on the response received from a user via the user interface, the server transmits an address retrieval program to the user device 220 through the Internet 221. The address retrieval program searches the memory and data storage devices of the user device 220 for e-mail address information. In an embodiment, once e-mail addresses are obtained, the address retrieval program sends an e-mail to each e-mail address via the Internet 221.

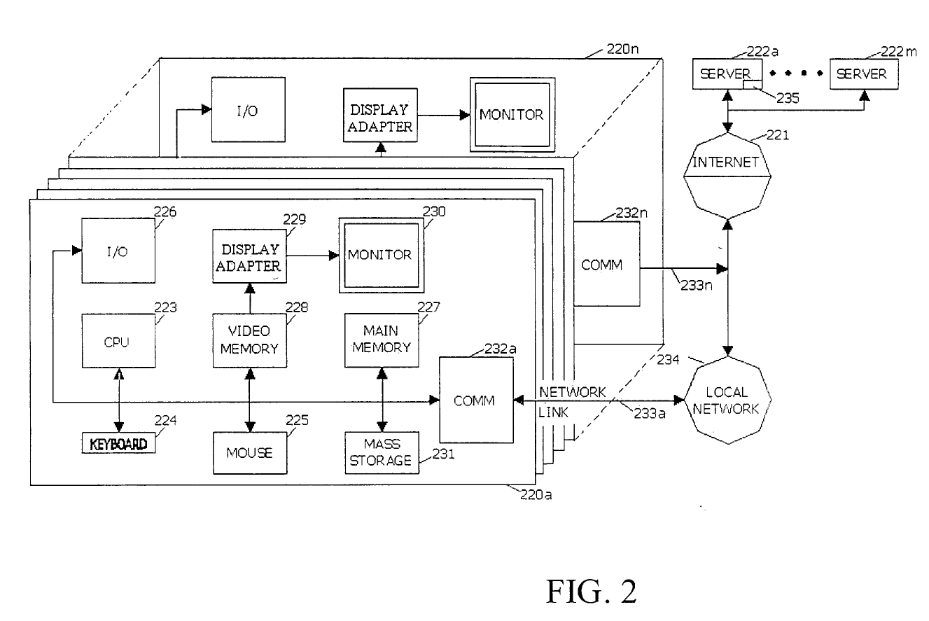

FIG. 2 shows a block diagram of a typical Internet client/server environment used by the user devices and servers in one embodiment of the present invention. User devices 220a-220n used by the users are connected to the Internet 221 through communication links 233a-233n. Optionally, a local network 234 may serve as the connection between some of the user devices 220a-220n, such as the user device 220a and the Internet 221. Servers 222a-222m are also connected to the Internet 221 through respective communication links. Servers 222a-222m include information and programs accessible by the user devices 220a-220n. In one embodiment of the present invention, programs for retrieving e-mail address book information reside on at least one of the servers 222a-222m and are accessible by users using one or more of the user devices 220a-220n.

In one embodiment of the present invention, each of the user devices 220a-220n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical user device. Video data from the video memory 228 is displayed on a Display screen 230 by a display adapter 229 under the control of the CPU 223. A communication device 232, such as a modem, provides access to the Internet 221. Optionally, one or more of user devices 220a-220n may be connected to a local network 234. An Input/Output (I/O) device 226 reads data from various data sources and outputs data to various data destinations.

Servers (hosts) 222a-222m are also computers and typically have architecture similar to the architecture of user devices 220a-220n. Generally, servers differ from the user devices in that servers can handle multiple telecommunications connections at one time. Usually, servers have more storage and memory capabilities, and higher speed processors. Some server (host) systems may actually be several computers linked together, with each handling incoming web page requests. In one embodiment, each server 222a-222m has a storage medium 235a-235m, such as a hard disk, a CD drive, or a DVD for loading computer software.

When software such as the software responsible for executing the processes in FIGS. 1 and 3 to 5 is loaded on the server 222a, an off-the-shelf web management software or load balancing software may distribute the different modules of the software to different servers 222a-222m. A server may utilize an operating system such as DOS, Microsoft Windows, or Linux. The server may use proprietary source, off the shelf, or open source software to generate and serve web pages. In an embodiment, the server uses Apache server software to generate and serve web pages. The page generating software generates web pages that have, for example, hypertext markup language (HTML) and Javascript components. Additionally, the server may be protected from unauthorized access by the use of a firewall, such as one produced by Checkpoint.

Therefore, in one embodiment, the computer programs and databases responsible for executing the present invention reside on one or more servers. Databases to carry out the processes of FIGS. 1 and 3 to 5 may be created, maintained and edited in many different types of database software including SQL, Access, FoxPro, and Oracle. In one embodiment of the present invention the database software is made by Oracle.

An exemplary web site location 235 is shown on server 222a in FIG. 2. The web site 235 is the user interface for accessing the database described below. The web site 235 has a unique address that is used by the users to access server 222a (in this example) and the web site location on the server 222a. The computer software for executing the processes of the present invention may also reside on the web site 235.

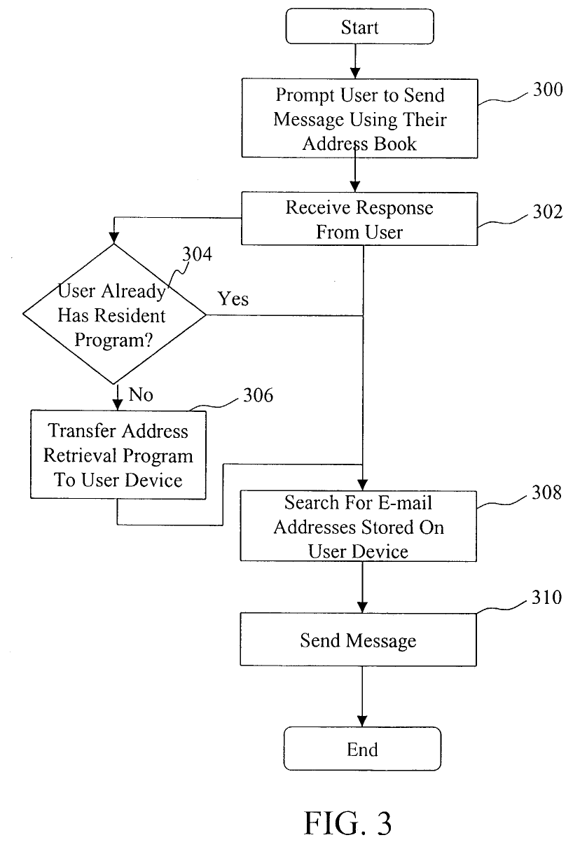

A method for distributing messages using an address book of a user is shown in FIG. 3. A user, using a user device with an Internet browser, accesses a website hosted by the server. As part of the webpage information passed to a user, the server prompts the user to send an advertisement to at least a subset of the e-mail addresses contained in address books on the user device, Box 300. The advertisement may contain, for example, information about a website including a description of the website. In an embodiment, the advertisement contains a link to a website that, when clicked on by an advertisement recipient, opens an Internet browser on the recipient's computer directed to the website.

If the server receives a user request to send the advertisement to at least a subset of the e-mail addresses contained in address books on the user device, Box 302, then the server checks to see if an address retrieval program has already been downloaded onto the user device, Box 304. If the address retrieval program is not found on the user device, then the address retrieval program is transferred to the user device, Box 306. In an embodiment, when the address retrieval program is installed, a flag is placed in a particular location in the memory or data storage devices of the user device to quickly indicate to the server in the future that the address retrieval program is installed.

In an embodiment, the address retrieval program is specific to the type of user device being used to access the server and the type of operating system running on the user device. Prior to transfer of the address retrieval program, the server checks the system parameters of the user device to determine what operating system is being used. Different address retrieval programs may be needed for different versions of Microsoft Windows® operating systems as well as for Palm®, Macintosh®, or other operating systems. In an alternative embodiment, the address retrieval program is adapted to be run across different operating systems on different user devices. For example, the address retrieval program may be run as a Java applet.

After the address retrieval program is loaded onto a user device, the address retrieval program searches throughout the user device's memory and data storage devices to locate all saved e-mail addresses, Box 308. In an embodiment, the address retrieval program locates address book type files. For example, the address retrieval program for a machine using Windows® searches for all files ending in “.WAB”, which are Windows Address Book files, utilized by Microsoft programs such as Microsoft Outlook®. The address retrieval program also searches for all files ending in “.mab”, which are address book files utilized by Netscape Navigator®. Once the address retrieval program locates the address book files, the address retrieval program extracts any e-mail addresses contained in the address book files.

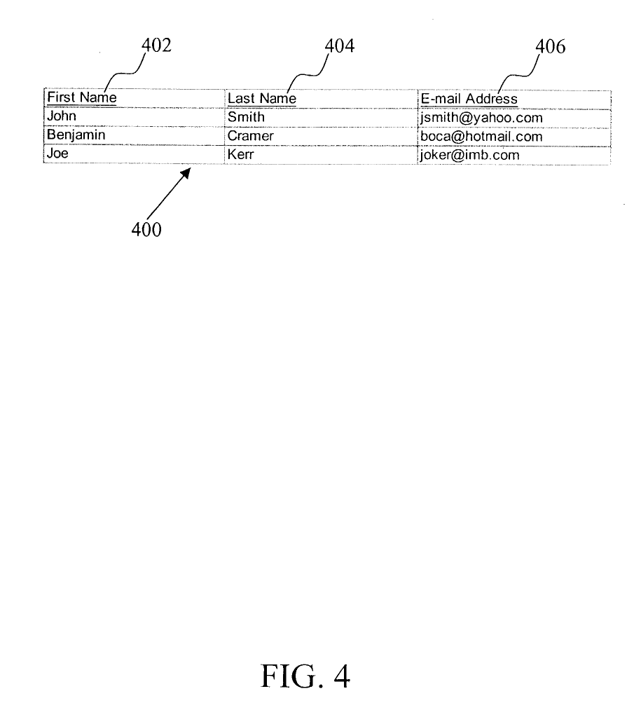

A sample address book file structure is shown in FIG. 4. The file 400 is a database containing several records. Fields in each record include first name 402, last name 404, and e-mail address 406. The fields in the record, and records in the database, may be separated by tabs, commas or other characters as is known to those skilled in the art. For example, a specific record may include the following information: (First Name=John, Last name=Smith, e-mail address=johnsmith@yahoo.com).

In an additional embodiment, the address retrieval software searches the contents of files on the user device for text in email address format, namely XXX@XXXX.XXX. There is no fixed number of characters before the “@”,from the “@” to the “.”, and after the “.”. The text between spaces may be searched for a “@” and a “.”. When an address is found, the address retrieval program compares the e-mail address found to those already in memory. If the found address is not already in memory, then the address is added to memory. This process generates a list of unique e-mail addresses.

Returning to FIG. 3, once the address retrieval program has retrieved any e-mail addresses in the address books saved in the memory and data storage devices of the user's computer, preselected messages such as advertisements are sent to the e-mail addresses retrieved. In an embodiment, the address retrieval program opens up an e-mail program. Once the e-mail program is open, the address retrieval program opens a new e-mail letter. Once the letter is open, the address retrieval program addresses an e-mail letter to all of the e-mail addresses found. The address retrieval program then inserts the preselected message and mails the letter. The e-mail program may be, for example, Microsoft Outlook, Netscape Communicator, or Eudora. In an alternative embodiment, the address retrieval program functions as an e-mail client and sends an e-mail directly to each retrieved e-mail address, rather than opening an additional e-mail program.

In an embodiment, the retrieved e-mail addresses are each inserted as blind carbon copy recipients so that the receiver does not see any of the other addressees. In another embodiment, the user's name and e-mail address are inserted into the “sender” field of the letter, so that the recipient knows who sent the letter. If the address retrieval program is unable to locate an e-mail address for the user, the user is prompted to enter a name and e-mail address information.

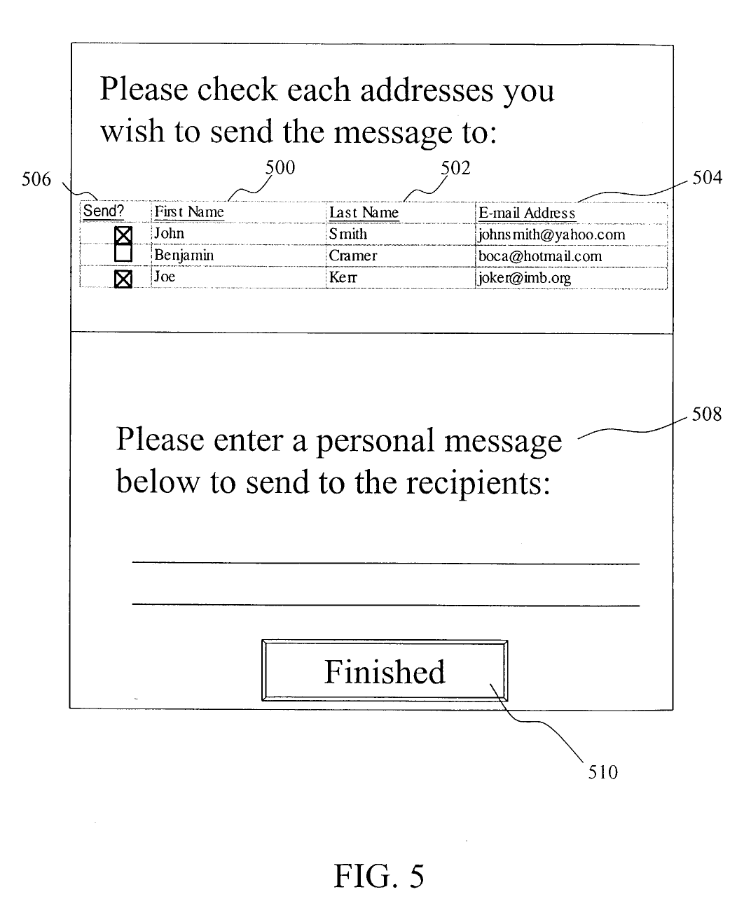

In an additional embodiment of the present invention, all of the e-mail addresses retrieved are displayed for the user, as shown in FIG. 5. The first name 500, last name 502 and e-mail address 504 of each potential recipient is displayed. The user is prompted to select one or more of the e-mail addresses to send the preselected message to. The user is prompted to place a check in a checkbox 506 next to each e-mail address that the user wishes to send the preselected message to. In an embodiment, the user is also prompted to enter a personal message to be sent along with the preselected message 508. Once the user has selected any recipients that they would like to send the preselected message to and entered any personal message that they wish to accompany the preselected message, the user presses the “finished” button 510. Once the “finished” button 510 is pressed, an e-mail is sent to any selected recipients.

In another embodiment of the present invention, the e-mail addresses retrieved by the address retrieval program are sent to the server. The server maintains a database of e-mail addresses to which a particular preselected message has been sent. Upon receipt of the e-mail address retrieved by the address retrieval program, the server checks to see if any of the e-mail addresses retrieved have already been sent the preselected message selected by the user. The server then sends the preselected message to those retrieved e-mail addresses that are not in the database of e-mail addresses that have been sent the preselected message. After sending the preselected message, the server adds the e-mail addresses to which the preselected message was sent to the database of e-mail addresses for that particular preselected message. This prevents an e-mail address from being sent multiple copies of a particular preselected message.

In an additional embodiment, the e-mail addresses sent to the server are encoded so that the server cannot see the actual e-mail addresses, but can compare the addresses to others. In another embodiment of the present invention, the addresses retrieved by the address retrieval program are sent to a third party who retains the addresses.

Each recipient who receives the preselected message is prompted to visit a website by clicking on a hotlink. Each recipient is also prompted to forward on the received preselected message to people in their address book. The process repeats itself, and the repetition distributes the advertisement in a very rapid manner. In an additional embodiment, the address retrieval program extracts any facsimile numbers from the address book files and sends the preselected message to the facsimile number rather than an e-mail address.

In an additional embodiment, the user is rewarded for each e-mail address to which the advertisement is sent. The number of e-mail addresses the advertisement is sent to is counted by the address retrieval program, which then sends an e-mail message containing the count to the server. The server tracks the number of preselected messages sent for rewarding the user. The server e-mails the user with information about the rewards the user has earned.

In yet another embodiment of the present invention, third party webpages contain advertisement links. The advertisement links contain a hotlink to the server 222 along with link parameters indicating the text and link to be sent in the preselected message. In an embodiment, the link to the server contains the actual text and link to be sent in the preselected message. Alternatively, the link to the server may contain a code that is cross-referenced in a database accessible by the server linking codes with text and links.

Once a user viewing the third party web page clicks on the advertisement link, the user's Internet browser is transferred to the server. Once the user's Internet browser is transferred to the server, the process described above for sending preselected messages to the e-mail addresses in an address book of a user is performed. By creating a situation where links to the server are placed in third party webpages, the services of the server may be tied to financial compensation based upon the number of advertisement links clicked through and the number of messages sent. Additionally, the server may send e-mail addresses to the third party web page provider for future mailings.

The preceding description has been presented with reference to presently preferred embodiments of the invention. Workers skilled in the art and technology to which this invention pertains will appreciate that alterations and changes in the described structure may be practiced without meaningfully departing from the principle, spirit and scope of this invention. Accordingly, the foregoing description should not be read as pertaining only to the precise system and method described and illustrated in the accompanying drawings, but rather should be read consistent with and as support for the following claims, which are to have their fullest and fairest scope.

What is claimed is:

1. A method utilizing a computer for distributing a preselected message using electronic mail addresses stored on a user device comprising:
receiving by the computer of a request to send the preselected message to electronic mail addresses stored on the user device;
retrieving electronic mail addresses stored on the user device; and
sending the preselected message to the electronic mail addresses retrieved from the user device.

2. The method utilizing a computer of claim 1 further comprising:
checking an operating system and user device type of the user device; and
transferring to the user device an address retrieval program specific to the operating system and device type of the user device.

3. The method utilizing a computer of claim 1 further comprising:
checking whether an address retrieval program is already stored in the user device; and
transferring to the user device an address retrieval program to the user device if no address retrieval program is stored in the user device.

4. The method utilizing a computer of claim 3 further comprising:
prompting the user to select at least one of the retrieved electronic mail addresses.

5. The method utilizing a computer of claim 4 further comprising:
prompting the user to enter a personal message; and
sending the personal message to the retrieved electronic mail addresses.

6. The method utilizing a computer of claim 1 further comprising tracking the number of addresses the preselected message is sent to.

7. The method utilizing a computer of claim 1 further comprising sending the retrieved electronic mail addresses to a server.

8. The method utilizing a computer of claim 7 further comprising addressing the preselected message with the retrieved electronic mail address listed as a blind carbon copy and the user listed as the sender.

9. A system for distributing messages to electronic mail addresses comprising:
a message server coupled to a computer network;
a user device coupled to the computer network;
wherein the message server is configured to:
receive a request to send a message to e-mail addresses stored on the user terminal;
retrieve electronic mail addresses stored on the user device; and
send a message to the electronic mail addresses retrieved from the user device.

10. The system for distributing messages of claim 9 wherein the message server is further configured to:
check an operating system and user device type of the user device; and
transfer to the user device an address retrieval program specific to the operating system and device type of the user device.

11. The system for distributing messages of claim 9 wherein the message server is further configured to:
check whether an address retrieval program is already stored in the user device; and
transfer to the user device an address retrieval program to the user device if no address retrieval program is stored on the user device.

12. The system for distributing messages of claim 11 wherein the message server is further configured to:
prompt the user to select at least one of the retrieved electronic mail addresses;
receive from the user a selection of retrieved electronic mail addresses to send a message to;
prompt the user to enter a personal message;
receive from the user a personal message; and
send the personal message to the selection of retrieved electronic mail addresses.

13. A computer readable medium having stored thereon a set of instructions including instructions for distributing messages, the instructions, when executed by a microprocessor cause the microprocessor to perform the steps of:
prompting a user to send a message to the electronic mail addresses stored on a user device;
receiving by the computer of a request to send a message to electronic mail addresses stored on the user device;
retrieving electronic mail addresses stored on the user device; and
sending the message to the electronic mail addresses retrieved from the user device.

14. The computer readable medium of claim 13 further comprising instructions to perform the steps of:
checking an operating system and user device type of the user device; and
transferring to the user device an address retrieval program specific to the operating system and device type of the user device.

15. The computer readable medium of claim 13 further comprising instructions to perform the steps of:
checking whether an address retrieval program has already been transferred to the user device; and
transferring to the user device an address retrieval program to the user device if no address retrieval program has been transferred to the user device.

16. The computer readable medium of claim 15 further comprising instructions to perform the steps of:
prompting the user to select at least one of the retrieved electronic mail addresses;
receiving from the user a selection of at least one retrieved electronic mail address;
prompting the user to enter a personal message; and
sending the personal message to the selected retrieved electronic mail addresses.

17. The computer readable medium of claim 16 further comprising instructions to perform the steps of:
tracking the number of addresses the message is sent to; and
addressing the message sent to the selected retrieved electronic mail addresses with the selected retrieved electronic mail address listed as a blind carbon copy and the user listed as the sender.
